(19) United States
(12) Patent Application Publication
(10) Pub. No.: US 2015/0117691 A1
(43) Pub. Date: Apr. 30, 2015

(54) WRIST ACCESSORY

(71) Applicant: John Hillyer Jennings, New York, NY (US)

(72) Inventor: John Hillyer Jennings, New York, NY (US)

(21) Appl. No.: 14/066,617

(22) Filed: Oct. 29, 2013

(51) Int. Cl. H04R 1/02

(52) U.S. Cl. CPC H04R 1/02; H04R 2420/07
USPC 381/334

(57) ABSTRACT

A wrist accessory apparatus (10) comprises a flexible band (15) and a control unit (20, 21). The band (15) is lightweight, flexible and elastic and is dimensioned for wrapping around the wrist of a user and maintaining the control unit in a flat comfortable position on the top of the user's wrist. In preferred forms, the control unit (20, 21) includes a circuit, speaker assembly and a play button mechanism. The control unit is structured and arranged to allow a preferred audio file to be played aloud. The band can be implemented with a variety of colors, shapes and sizes to fit a user's wrist accordingly.

### CROSS-REFERENCE TO RELATED APPLICATIONS

This application relates to co-pending U.S. Provisional Patent Application 61/720,170, entitled, “WRIST TUNES MUSICAL BRACELET”, filed Oct. 30, 2012; which co-pending application is hereby incorporated by reference in its entirety.

### BACKGROUND OF THE INVENTION

The present invention relates to an accessory worn on a user's wrist having a flexible, elastic band connected to a hard shell enclosure encasing audio equipment for playing a desired musical selection.

Community spirit in connection with local sports teams is at an all-time high. Fans of a local sports team have increasingly wanted to become more involved in the game of the team they support by holding rallies, cheering and collectively rooting for their team. In this connection, fight songs are often played at the venue where the home team plays its games, particularly in college football.

At the University of Georgia, for example, the fight song is played after touchdowns, field goals, and extra points scored by the football team. Georgia fans often replace the words in the fight song with a disparaging comment about a rival or a particular school that the Bulldogs happen to be playing. Fans have been known to sing their team's fight song multiple times before, during and after a game. In this connection, fans have been wanting a wearable device that can play their favorite team's fight song on a localized level, namely when and where they want to hear it.

In this regard, mobile phones do have applications to play certain fight songs. However, such devices are expensive, the applications are clumsy and they require taking out the phone and navigating through several menus and screens before the desired fight song is played. In addition, the present state of such application does not allow for united play of such fight songs among multiple devices, which is a desire for fans in order to maximize the effect of their support for their local team.

As such, there is a need for a low cost mobile device with the ability to play a fight song in a single button mode. A desire for linking such mobile devices in order to play such fight song in unison is also apparent. Such a device should be lightweight and comfortable for the wearer in all weather conditions.

Moreover, there is a desire for having an inexpensive mobile device with the ability to store different musical selections potentially including all large universities across the country and even global sports organizations.

In addition, there is a desire for an inexpensive device including pop music as well. Popular singers and bands have devoted followers across the country and across the globe that will do anything to express their love and admiration for their favorite musicians. Teen idol musicians draw huge crowds to their concerts, and music merchandise is a large source of revenue for the artists. Fans of these artists, including young females, have wanted an easy-to-wear and easy-to-use bracelet that could play their favorite song out loud.

### SUMMARY OF THE INVENTION

The present invention includes a bracelet accessory to be worn on the wrist of a user having a fixed control unit flexibly connected to a flexible, elastic band such that the accessory rests on the wrist of the user with the control unit lying comfortably flat on top of the user's wrist. The control unit includes electronics and batteries structured and arranged to play an audio file when the user presses a play button disposed on one half shell of the control unit. The play button is connected either electronically or mechanically to batteries and the electronics to play an audio file.

In a first embodiment, the present invention includes a wrist accessory including a band made of an elastic material, the band having a unitary structure flexibly connected at two distal ends to a control unit, the control unit having a first shell and a second half shell structured and arranged to be joined and form an interior cavity of the control unit; inside the interior cavity, the control unit includes a printed circuit board in electrical communication with an integrated circuit and at least one battery to power the PCB and IC, a speaker electrically connected to the PCB, the IC and the at least one battery, where the first shell includes a play button disposed thereon in communication with the PCB, the IC, and at least one battery such that depression of the play button initiates the playing of at least one audio file stored on the PCB; and the wrist band sized and connected to the control unit such that the control unit rests stably upon a user's wrist in the resting state due to the elasticity of the band.

In some embodiments there are first and second wedge portions disposed at the distal ends of the bands, where the wedge portions are structured and arranged to frictionally engage the interior of the first and second half shells when joined to flexibly secure the control unit.

In some embodiments there is a first pin and second pin for securing the first and second half shells, where the first and second pin are structured and arranged to be frictionally engaged with a first connection aperture and second connection aperture respectively, disposed on each of the two distal ends of the band, respectively.

Some embodiments include light emitting diodes disposed within the control unit electrically connected to the PCB, the IC and the battery and synced to the audio file.

Some embodiments include a transmitter and a receiver for syncing wirelessly with at least one remote device.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a perspective view of the wrist accessory according to one embodiment of the present invention;

FIG. 2 is a front view of the exterior of the bracelet, showing the side with the speaker holes 23, according to one embodiment of the present invention.

FIG. 3 is a front view of the exterior of the bracelet, showing the side with play button 30 according to one embodiment of the present invention.

FIG. 4 is a top view of the wrist accessory according to one embodiment of the present invention; and

FIG. 5 is an exploded view of the elements included within the wrist accessory according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

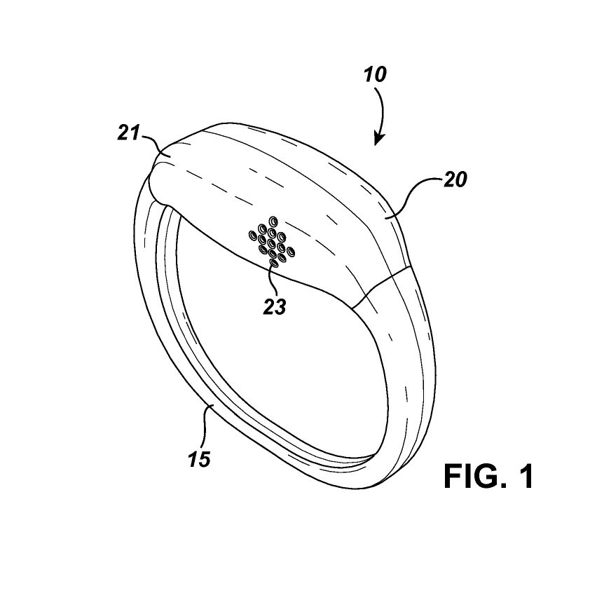

Referring to FIG. 1 there is shown a perspective view of the wrist accessory 10 having a control unit (20, 21) with a first half shell 20 and a second half shell 21 connected to flexible, elastic band 15. Second half shell 21 includes speaker holes 23.

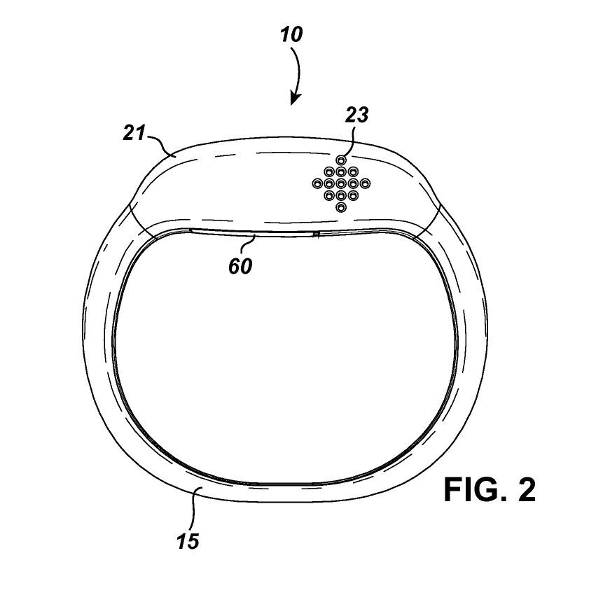

Referring to FIG. 2 there is shown a side view of accessory 10 showing access panel 60 which allows access to the interior of control unit 20, 21 in order to change the batteries.

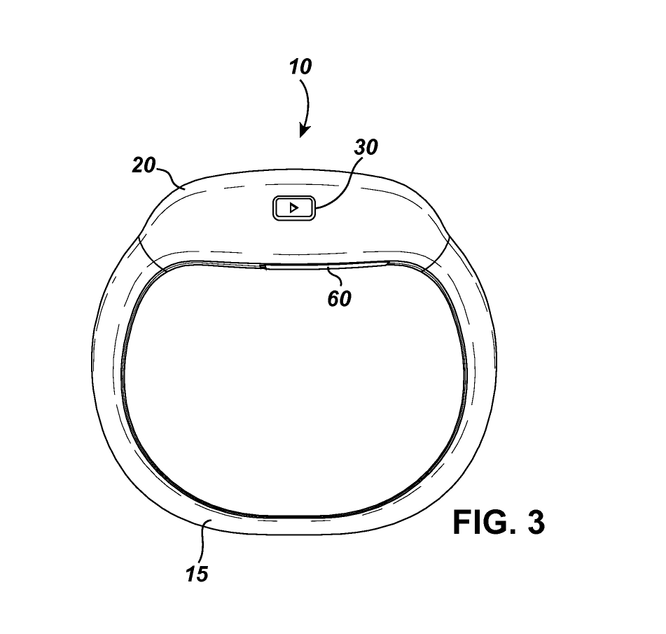

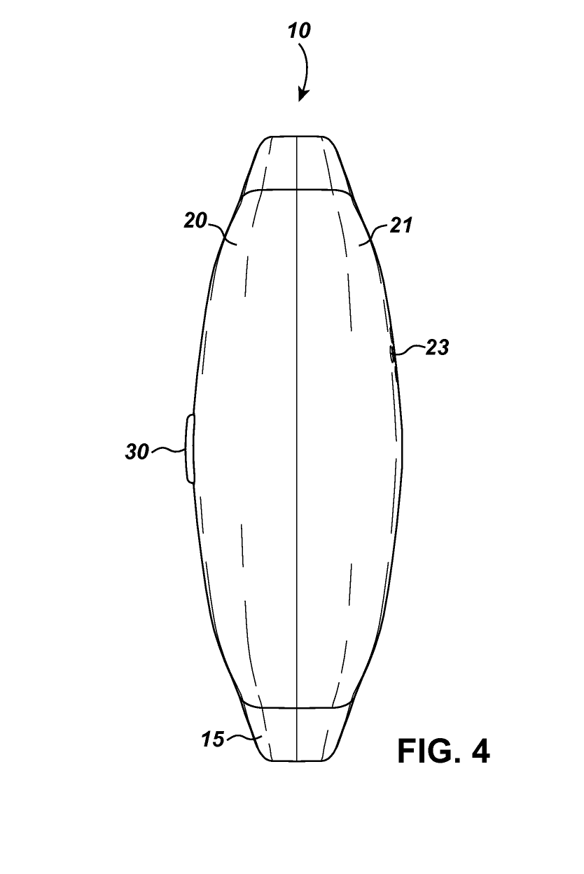

Referring to FIG. 3 there is shown another side view of accessory 10 showing play button 30 located on first half shell 20. FIG. 4 shows a top view of accessory 10.

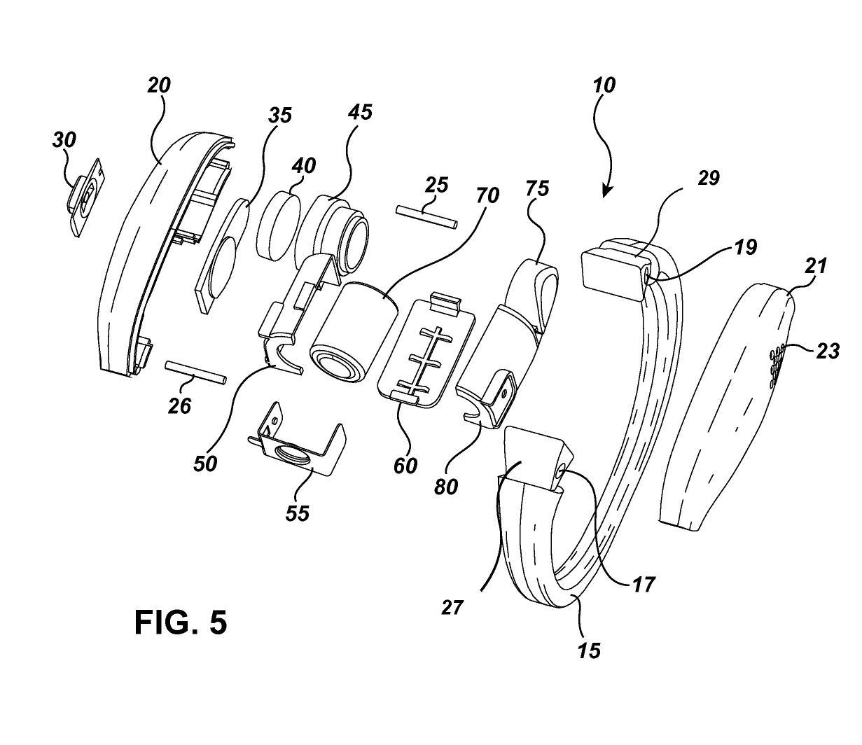

Referring now to FIG. 5 there is shown an exploded view of the interior elements of control unit 20, 21. Control unit 20, 21 is adapted to house a first battery housing 50 connected to a second battery housing 80, where the second battery housing 80 includes a speaker chamber 75 adapted to receive speaker 45. Access panel 60 is adapted to connect with the bottom battery housing 50, 80 after the two halves are joined to surround battery 70. Battery housing connector 55 connects the battery housing 50, 80.

Play button 30 is interconnected with first half shell 20 and is adapted for either mechanical or electrical communication with printed circuit board (PCB) 35. PCB 35 communicates with integrated circuit (IC) 40 which is juxtapositioned on the back side of speaker 45. In some embodiments PCB 35 includes the IC 40 and passive components, including resistors and capacitors, mounted thereon. IC 40 can be a micro-controller that detects the play button 30 activation, generates the music and drives the speaker.

PCB 35 is adapted to include a storage unit and electronics adapted to play an audio clip stored thereon. In order to activate the audio clip, a user must simply press play button 30. Once activated, the audio clip will play out loud at a volume of about 65 decibels. In some embodiments the accessory can include volume control. Pressing play button 30 again during the playing of the audio clip will turn the audio clip off.

The device comes with a preset audio clip, and the audio clip is non-reloadable. However there are embodiments that include means to modify or change the audio clip stored on the device. Battery 70 may include multiple batteries, and battery 70 is designed to be replaceable via access panel 60. The band is made of a lightweight elastic silicone in order to fit various wrist sizes. Any lightweight and flexible material is suitable for band 15. Different sizes may be made (such as Small, Medium, Large) to accommodate an even larger range of wrist sizes.

In a preferred embodiment accessory 10 will be water-resistant, and may be water-proof. A seal may be inserted within shell 21 proximal to speaker holes 23 in order to maintain the interior of control unit 20, 21 in a dry state. The speaker holes 23 are ideally located farthest from the thumb (when worn on the left wrist) on the side of the bracelet facing down toward the hand, which allows for the most water resistance. Gravity will cause water to fall/drip out of the speaker holes should any water enter. Water-resistant fabric may cover either the inside or outside of speaker holes 23.

Control unit 20, 21 is secured together with pins 25 and 26 which are structured and arranged to frictionally engage interior of first half shell 20 and second half shell 21 respectively. Pins 25 and 26 are arranged for insertion into first connection aperture 17 and second connection aperture 19 respectively. Each of first and second aperture sections are arranged to frictionally engage the interior of first and second half shells 20, 21 respectively when half shells 20, 21 are brought into communication with each other. In a preferred embodiment these connection points can withstand at least 23 lbs. of force.

First and second apertures 17 and 19 are located on the distal ends of band 15 and located on wedge portions 27 and 29 respectively. Wedge portions 27, 29 are structured and arranged to snugly fit within shells 20, 21 when they are joined. Like band 15, wedge portions 27 and 29 are preferably made from flexible material such that when a user places accessory 10 on his or her wrist the wedge portions 27 and 29 ensure that control unit 20, 21 remain stable and in a flat position on the top of the user's wrist in a comfortable position without irritating the skin of the user.

Additional embodiments of the wrist accessory bracelet may play multiple audio files and include LED lights having a light pattern according to the audio file being played. In some embodiments the shell includes electronics for connecting wirelessly to Wi-Fi, radio signals, cellular signals, Bluetooth and other standard wireless signals. The accessory can include standard hard line connections to computers and other mobile devices, all for the purpose of updating software and/or music selections loaded onto the PCB 35.

Preferably the accessory can be paired or synced to other accessories for a uniform playing of audio and lights, for example in a stadium to show spirit for a favorite team or performer. In some embodiments the accessory can be paired or synced with mobile phones and wireless networks to sync to other spirit-driven devices such as pins, hats, shirts and stadium devices. As for the sport stadium or concert stadium, it may be very noisy and the music from the bracelet may not be heard, so the lighting pattern may be more noticeable. The song from one bracelet could activate a song on a second bracelet. In some embodiments there exist electronics to allow linking wirelessly to a smart device which allows the accessory to play a song that is selected in the application on the smart device.

Additional embodiments include allowing users to change the song by linking the bracelet to a laptop or a smart device so that the accessory can have access to an unlimited amount of music or audio/video files. The song downloading could be by a wire plugged into the audio jack of the iPhone/Android Phone or other smart device, Then the selection of the songs could be by the application wirelessly, and the user could use the application to start playing the selected song wirelessly too.

In some embodiments there will be included a 2-chips solution instead of 1-chip, having SoC plus SPI Flash. Some other embodiments may include additional components such as a visual display, a microphone and a larger power supply.

It will be apparent to one of skill in the art that described herein is a wrist accessory as described and claimed herein. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A wrist accessory comprising:
a band made of an elastic material, the band having a unitary structure flexibly connected at two distal ends to a control unit,
the control unit comprising:
a first shell and a second half shell structured and arranged to be joined and form an interior cavity of the control unit;
inside the interior cavity, the control unit includes a printed circuit board in electrical communication with an integrated circuit and at least one battery to power the PCB and IC, a speaker electrically connected to the PCB, the IC and the at least one battery,
where the first shell includes a play button disposed thereon in communication with the PCB, the IC, and at least one battery such that depression of the play button initiates the playing of at least one audio file stored on the PCB; and
the wrist band sized and connected to the control unit such that the control unit rests stably upon a user's wrist in the resting state due to the elasticity of the band.

2. The wrist accessory according to claim 1, including first and second wedge portions disposed at the distal ends of the bands, the wedge portions structured and arranged to frictionally engage the interior of the first and second half shells when joined to flexibly secure the control unit.

3. The wrist accessory according to claim 2 further comprising a first pin and second pin for securing the first and second half shells, where the first and second pin are structured and arranged to be frictionally engaged with a first connection aperture and second connection aperture respectively, disposed on each of the two distal ends of the band, respectively.

4. The wrist accessory according to claim 1 further comprising light emitting diodes disposed within the control unit electrically connected to the PCB, the IC and the battery and synced to the audio file.

5. The wrist accessory according to claim 2 further comprising a transmitter and a receiver for syncing wirelessly with at least one remote device.
